(19) United States
(12) Patent Application Publication
(10) Pub. No.: US 2009/0140935 A1
(43) Pub. Date: Jun. 4, 2009

(54) Antenna device and electronic apparatus

(75) Inventors: Toshiyuki Hirota, Hino-shi (JP); Hironori Motoe, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/259,854

(22) Filed: Oct. 28, 2008

(30) Foreign Application Priority Data
Nov. 30, 2007 (JP) 2007-310642

(51) Int. Cl. H01Q 1/38; H01Q 1/24

(52) U.S. Cl. 343/702; 343/700 MS

(57) ABSTRACT

According to one embodiment, there is provided an antenna device including a base substrate having a power-feeding pattern, and a stackable block stacked on the base substrate and fixed to the surface of the base substrate, the stackable block having an element pattern with one end connected to the power-feeding pattern and the other end extendible in a direction of stacking another stackable block on the stackable block.

### CROSS-REFERENCE TO RELATED APPLICATIONS

This application is based upon and claims the benefit of priority from Japanese Patent Application No. 2007-310642, filed Nov. 30, 2007, the entire contents of which are incorporated herein by reference.

### BACKGROUND

1. Field

One embodiment of the present invention relates to an antenna device suitable for a transportable compact electronic apparatus provided with a radio unit.

2. Description of the Related Art

An internal antenna using a printed circuit board is often used in a transportable compact electronic apparatus provided with a radio unit. An internal antenna using a printed circuit board is configured by forming an element pattern functioning as an antenna radiator on a printed circuit board having a structure of a printed wiring board. An element pattern is made of conductive foil, similar to a circuit wiring pattern in a printed wiring board. In a conventional antenna device using such a printed circuit board, an element pattern is formed on a single board or a multiplayer board. Such antenna device is disclosed in Jpn. Pat. Appln. KOKAI Publication Nos. 2002-100915, 2005-005987 and 2004-186730, for example.

In the above conventional antenna device using a conventional printed circuit board, antenna elements are specified by an element pattern formed on the surface of a printed circuit board, and a specific antenna substrate must be designed for the configuration of each apparatus. Further, as an element pattern is formed on the surface (plane) of a substrate, a mounting space spreading in the horizontal direction is required, and the mounting flexibility is restricted.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are exemplary perspective views showing an example of an antenna device according to a first embodiment of the invention;

FIGS. 2A and 2B are exemplary perspective views showing an example of an antenna device according to a second embodiment of the invention;

FIGS. 3A and 3B are exemplary perspective views showing an example of an antenna device according to a third embodiment of the invention;

FIGS. 4A and 4B are exemplary perspective views showing an example of an antenna device according to a fourth embodiment of the invention;

FIGS. 5A and 5B are exemplary perspective views showing an example of an antenna device according to a fifth embodiment of the invention;

FIG. 6 is an exemplary perspective view showing an example of the configuration of a stackable block applicable to each embodiment of the invention;

FIG. 7 is an exemplary perspective view showing an example of the configuration of a stackable block applicable to each embodiment of the invention;

FIG. 8 is an exemplary perspective view showing an example of the configuration of a stackable block applicable to each embodiment of the invention;

FIG. 9 is an exemplary perspective view showing an example of the configuration of a stackable block applicable to each embodiment of the invention; and

FIG. 10 is an exemplary perspective view showing an example of the configuration of an electronic apparatus according to a sixth embodiment of the invention.

### DETAILED DESCRIPTION

Various embodiments according to the invention will be described hereinafter with reference to the accompanying drawings. In general, according to one embodiment of the invention, there is provided an antenna device including a base substrate having a power-feeding pattern, and a stackable block stacked on the base substrate and fixed to the surface of the base substrate, the stackable block having an element pattern with one end connected to the power-feeding pattern and the other end extendible in a direction of stacking another stackable block on the stackable block.

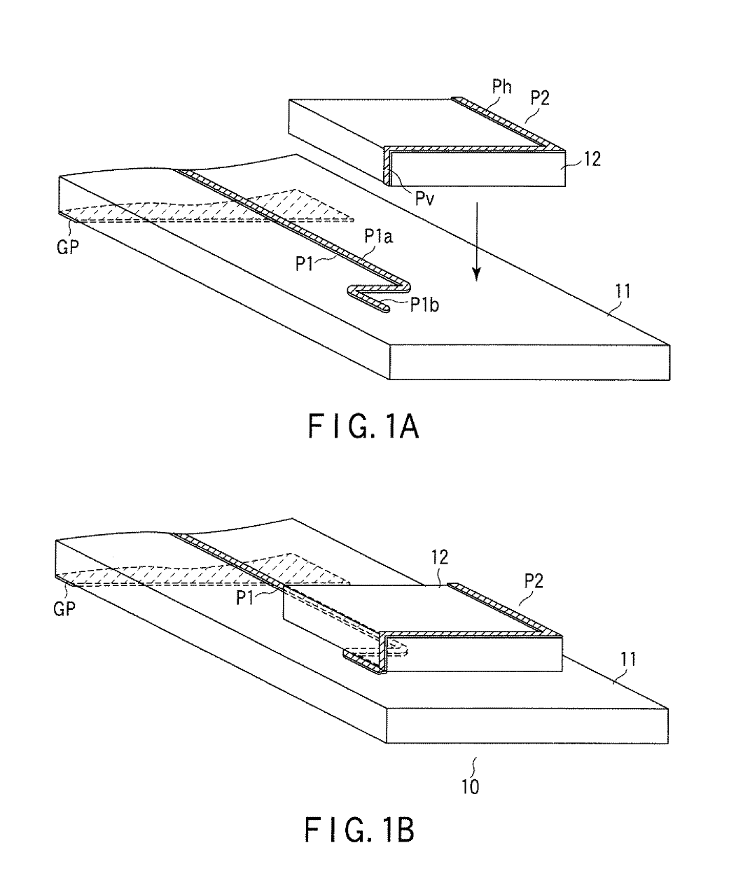

FIGS. 1A and 1B show an example of the antenna device according to a first embodiment of the invention. FIG. 1A shows the state before the elements of the antenna device are combined. FIG. 1B shows the state after the elements of the antenna device are combined.

As shown in FIGS. 1A and 1B, the antenna device according to the first embodiment comprises a base substrate 11 having a power-feeding pattern 21, and a stackable block (substrate) 12 stacked on the base substrate 11 and fixed to the surface of the substrate, the stackable block 12 having an element pattern P2 with one end conductively connected to the power-feeding pattern P1 and the other end extendible in a direction of stacking another stackable block on the stackable block 12.

The base substrate 11 and stackable block 12 are configured using printed circuit boards, and the power-feeding pattern P1 and element pattern P2 are made of conductive foil.

For the base substrate 11 and stackable block 12, printed wiring boards with a thickness of 1.6 mm to 3.2 mm may be used as base materials.

The base substrate 11 has the power-feeding pattern P1 on one side, and a ground pattern GP for impedance matching with the power-feeding pattern P1 on the other side. The power-feeding pattern P1 has an antenna lead P1a and an element connection terminal P1b, which are connected as a circuit to an antenna connector of a not-shown radio apparatus.

The stackable block 12 includes a hexahedral printed circuit board stackable to several stages, and is fixed to the base substrate 11 with an adhesive, for example. The element pattern P2 has a partial element pattern Pv which is raised in the direction orthogonal to the surface or the base substrate 11, and provided along the ridge on one side of the stackable block 12, and a partial element pattern Ph which is extended from the pattern Pv and provided on the upper surface of the stackable block 12. The partial element pattern Pv is called a side pattern, and the partial element pattern Ph is called a plan pattern. In the embodiment shown in FIGS. 1A and 1B, the side pattern Pv and plan pattern Ph are formed along ridges orthogonal to each other. The lower end of the side pattern Pv is conductively connected to the element connection terminal P1b of the power-feeding pattern P1 provided on the base substrate 11. This conductive connection may be made by any means of soldering, using a conductive adhesive, and pressure welding.

In such an antenna device formed by stacking the stackable block 12 on the base substrate 11, a cubic antenna 10 is configured, rising from the element connection terminal P1b of the power-feeding pattern P1 to the direction of stacking the block 12 through the side pattern Pv of the element pattern P2, and spreading in the horizontal direction on the upper surface of the stackable block 12 through the plan pattern Ph. The stackable block 12 stacked on the base substrate 11 is not limited to the element pattern configuration shown in the drawing. Stackable blocks of various element configurations as shown later may be used, considering the antenna mounting space and required directivity.

In the antenna device formed by stacking a printed circuit board according to the above embodiment, the antenna elements are not extended along the surface of the base substrate 11, but extended in the direction of stacking the stackable block 12 through the stackable block 12. Therefore, an antenna module comprising a printed circuit board can be made compact, and an antenna module having a desired configuration of elements can be easily realized.

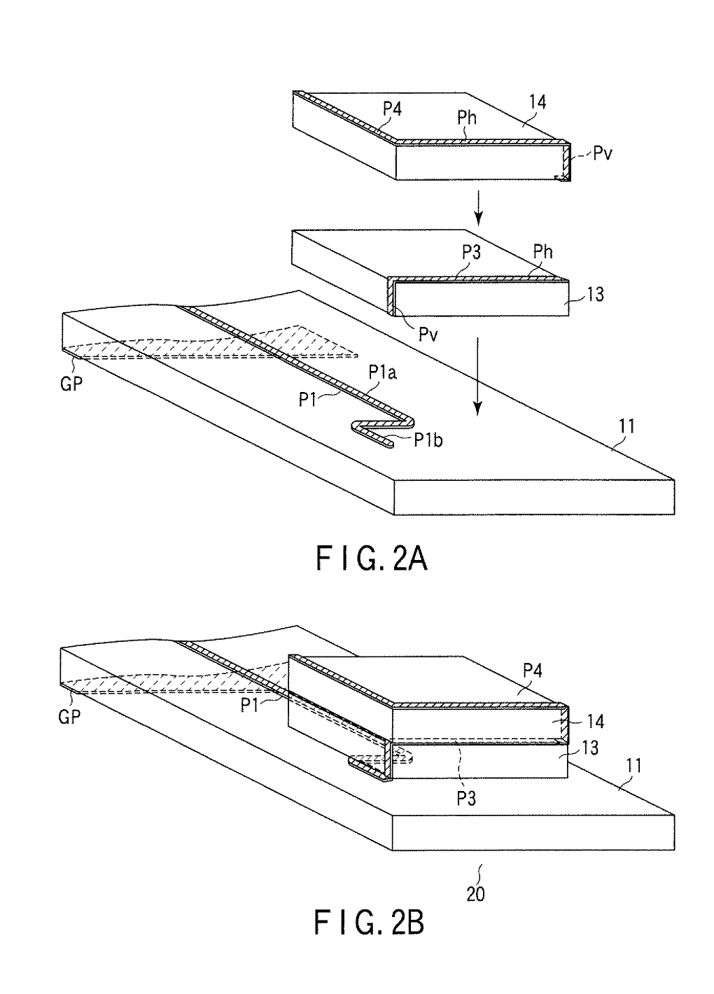

FIGS. 2A and 2B show an example of an antenna device according to a second embodiment of the invention. FIG. 2A shows the state before the elements of the antenna device are combined. FIG. 2B shows the state after the elements of the antenna device are combined. The antenna device according to the second embodiment uses the base substrate 11 according to the first embodiment as a common substrate. Therefore, an explanation on the configuration of the base substrate 11 will be omitted.

As shown in FIGS. 2A and 2B, the antenna device according to the second embodiment comprises a base substrate 11 having a power-feeding pattern P1, a stackable block (substrate) 13 stacked on the base substrate 11 and fixed to the surface of the substrate, the stackable block 13 having an element pattern P3 with one end conductively connected to the power-feeding pattern P1 and the other end extendible in a direction of stacking another stackable block on the stackable block 13, and a stackable block 14 stacked on the stackable block 13 and fixed to the block, the stackable block 14 having an element pattern P4 with one end connected conductively to the extended end of the element pattern P3 provided on the stackable block 13 and the other end extendible in a direction of stacking another stackable block on the stackable block 13.

Similar to the stackable block 12 shown in the first embodiment, the stackable blocks 13 and 14 are configured using hexahedral printed circuit boards stackable to several stages, and are fixed to the base substrate 11 with an adhesive, for example. Similar to the stackable block 12 shown in the first embodiment, the element patterns P3 and P4 provided on the stackable blocks 13 and 14 have a side pattern Pv and a plan pattern Ph. The element patterns P3 and P4 provided on the stackable block 13 and 14 are formed along the ridges where the side pattern Pv and plan pattern Ph are orthogonal to each other.

The antenna of the second embodiment formed by stacking stackable blocks may be assembled by stacking stackable block one by one on the base substrate 11, or by previously stacking stackable blocks, conductively connecting antenna elements, and then bonding the blocks to the base substrate 11.

By conductively connecting the lower end of the side pattern Pv provided on the stackable block 13 to the element connection terminal P1b of the power-feeding pattern P1 provided on the base substrate 11, and conductively connecting the lower end of the side pattern Pv provided on the stackable block 14 to the end (the extended end) of the plan pattern Ph extended from the side pattern Pv provided on the stackable block 13, a cubic antenna 20 having a 2-stage element structure is configured, spreading in the direction orthogonal to the surface of the base substrate 11.

By combining and stacking two stackable blocks 13 and 14 on the base substrate 11, a cubic antenna 20 having an element structure is configured, rising from the element connection terminal P1b of the power-feeding pattern P1 provided on the base substrate 11 to the direction of stacking the block 13 through the side pattern Pv of the element pattern P3 provided on the stackable block 13, extending along the ridge through the plan pattern Ph on the surface of the stackable block 13, rising in the direction of stacking the stackable block 14 through the side pattern Pv of the element pattern P3 provided on the stackable block 14, and spreading in the horizontal direction on the upper surface of the stackable block 14 through the plan pattern Ph.

By using the stackable block 12 used in the first embodiment as a stackable block common to the second embodiment, and stacking the stackable block 12 on the stackable block 14, though not shown here, a cubic antenna spreading in the direction orthogonal to the surface of the base substrate 11 is configured. In this antenna device, by conductively connecting the lower end of the side pattern Pv provided on the stackable block 12 to the end of the plan pattern Ph extended from the side pattern Pv provided on the stackable block 14, it is possible to realize a cubit antenna having a multi-stage element structure spreading further in the direction orthogonal to the surface of the base substrate 11.

In the antenna device according to the second embodiment, the antenna element is not extended in the horizontal direction on the surface of the base substrate 11. Rather, stackable blocks extend the antenna element in the stacking direction from the base substrate 11. Therefore, an antenna module comprising a printed circuit board can be made compact, and an antenna module having a desired configuration of elements can be easily realized.

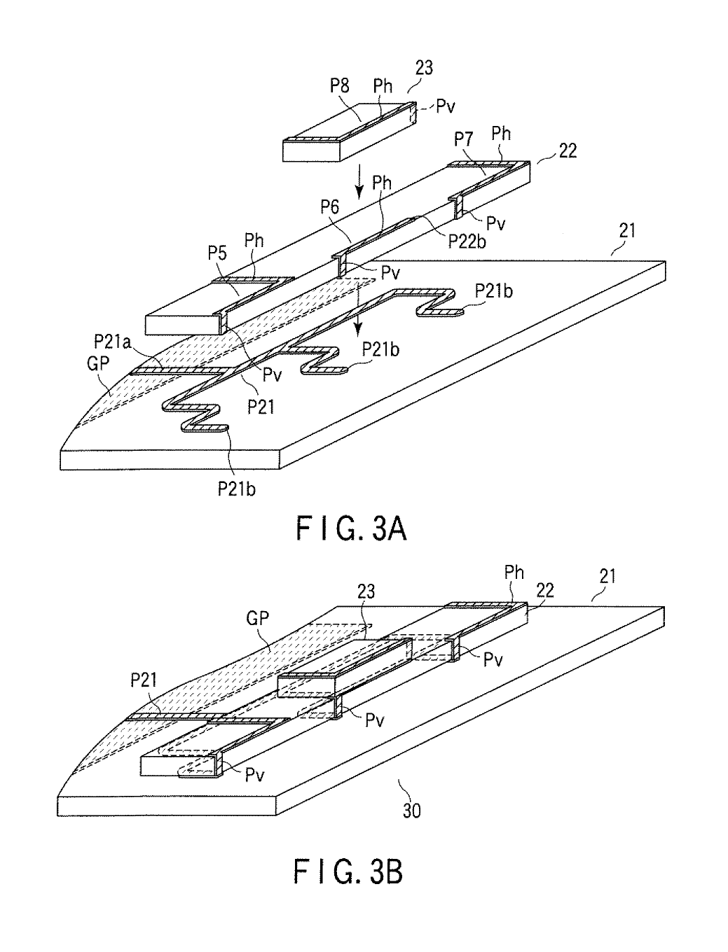

FIGS. 3A and 3B show an example of an antenna device according to a third embodiment. FIG. 3A shows the state before the elements of the antenna device are combined. FIG. 3B shows the state after the elements of the antenna device are combined.

As shown in FIGS. 3A and 3B, the antenna device according to the third embodiment comprises a base substrate 21 having a power-feeding pattern P21 and element connection terminals P21b, P21b and P21b (three in this embodiment) branched from an antenna lead 21a of the power-feeding pattern P21, a stackable block (substrate) 22 stacked on the base substrate 21 and fixed to the surface of the substrate, the stackable block 22 having element patterns P5, P6 and P7 corresponding to the element connection terminals P21b with one ends connected respectively and conductively to the corresponding element connection terminals P21b of the power-feeding pattern P21 and the other ends extendible in a direction of stacking another stackable block on the stackable block 22, a stackable block 23 stacked on the stackable block 22, the stackable block 23 having an element pattern P8 with one end connected conductively to an element extended end P22b of the element pattern P6 provided on the stackable block 22 and the other end extendible in a direction of stacking another stackable block on the stackable block 23.

Each of the element patterns P5, P6, P7 and P8 provided on the stackable blocks 22 and 23 have a side pattern Pv and a plan pattern Ph. In this embodiment, among the element patterns P5, P6 and P7 provided on the stackable block 22, the element length of the element pattern P6 is further extended by the stackable block 23, and the element end (the end of the plan pattern Ph extended from the side pattern Pv) of the element pattern P6 is regarded as an element extended end P22b.

By individually and conductively connecting the lower ends of the side patterns Pv, Pv and Pv provided on the stackable block 22 to the element connection terminals P21b, P21b and P21b of the power-feeding pattern P21 provided on the base substrate 21, and conductively connecting the tower end of the side pattern Pv provided on the sack block 23 to the element extended end P22b, by regarding the end of the plan pattern Ph extended from the side pattern Pv provided on the stackable block 22 as an element extended end P22b, a cubic antenna 30 having a three-branch element structure spreading in the direction orthogonal to the surface of the base substrate 21 is configured.

By combining and stacking two stackable blocks 22 and 23 on the base substrate 21, the cubic antenna 30 having a three-branch element structure is configured, rising from the element connection terminals P21b, P21b and P21b of the power-feeding pattern P21 provided on the base substrate 21 to the direction of stacking the block 22 through each side pattern Pv of the element patterns P5, P8 and P7 provided on the stackable block 22, extending along the ridge through the plan pattern Ph on the surface of the stackable block 22, rising in the direction of stacking the stackable block 23 through the side pattern Pv of the element pattern P8 provided on the stackable block 23, and spreading in the horizontal direction on the upper surface of the stackable block 23 through the plan pattern Ph.

In the antenna device according to the third embodiment, the antenna element is not extended in the horizontal direction on the surface of the base substrate 21. Rather, stackable blocks extend the antenna element in the stacking direction from the base substrate 21. Therefore, an antenna module comprising a printed circuit board can be made compact, and an antenna module having a desired configuration of elements can be easily realized. An example of the above third embodiment is shown as a cubic antenna having a three-branch element structure. The third embodiment is not limited to this example, and may be easily embodied as a cubic antenna having a two-branch element structure, or a cubic antenna having four or more branch element structure. Further, the number of stages of a stackable block, and the element pattern shape can be freely changed.

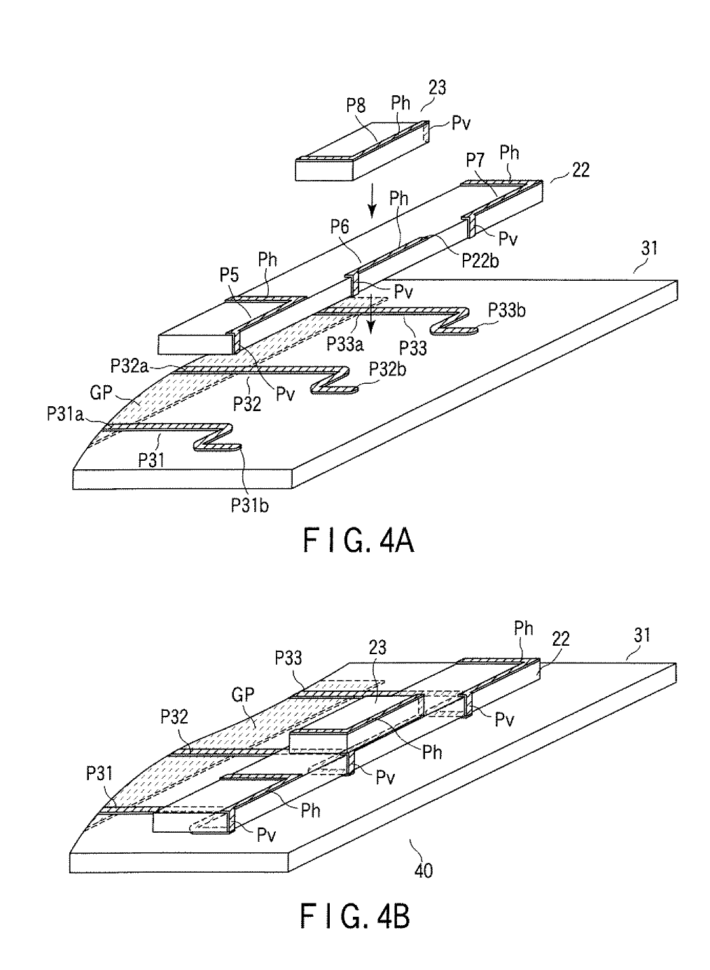

FIGS. 4A and 4B show an example of an antenna device according to a fourth embodiment of the invention. FIG. 4A shows the state before the elements of the antenna device are combined. FIG. 4B shows the state after the elements of the antenna device are combined. The antenna device according to the fourth embodiment uses the base substrate 22 of the third embodiment as a common substrate (a common stackable block).

As shown in FIGS. 4A and 4B, the antenna device according to the fourth embodiment comprises a base substrate 31 having three power-feeding patterns P31, P32 and P33 having independent circuits, a stackable block 22 stacked on the base substrate 31 and fixed to the surface of the substrate, the stackable block 22 having element patterns P5, P6 and P7 corresponding to the element connection terminals P31b, P32b and P33b of the power-feeding patterns P31, P32 and P33 with one ends connected respectively and conductively to the corresponding element connection terminals P31b, P32b and P33b of the power-feeding patterns P31, P32 and P33 and the other end extendible in a direction of stacking another stackable block on the stackable block 22, a stackable block 23 stacked on the stackable block 22, the stackable block 23 having an element pattern P8 with one end connected conductively to an element extended end P22b of the element pattern P6 provided on the stackable block 22 and the other end extendible in a direction of stacking another stackable block on the stackable block 23.

Each of the element patterns P5, P6, P7 and P8 provided on the stackable blocks 22 and 23 have a side pattern Pv and a plan pattern Ph. In this embodiment, among the element patterns PS, P6 and P7 provided on the stackable block 22, the element length of the element pattern P6 is further extended by the stackable block 23, and the element end (the end of the plan pattern Ph extended from the side pattern Pv) of the element pattern P6 is regarded as an element extended end P22b.

By individually and conductively connecting the lower ends of the side patterns Pv, Pv and Pv provided on the stackable block 22 to the element connection terminals P31b, P32b and P33b of the power-feeding patterns P31, P32 and P33 provided on the base substrate 31, and conductively connecting the lower end of the side pattern Pv provided on the sack block 23 to the element extended end P22b, by regarding the end of the plan pattern Ph extended from the side pattern Pv provided on the stackable block 22 as an element extended end P22b, a cubic composite antenna 40 having three independent cubic antennas spreading in the direction orthogonal to the surface of the base substrate 31 is configured.

By combining and stacking two stackable blocks 22 and 23 on the base substrate 31, the cubic composite antenna 40 having three independent cubic antennas is configured, rising from the element connection terminals P31b, P32b and P33b of three power-feeding patterns P31, P32 and P33 having three independent circuits provided on the base substrate 31 to the direction of stacking the block 22 through each side pattern Pv of the element patterns P5, P6 and P7 provided on the stackable block 22, extending along the ridge through the plan pattern Ph on the surface of the stackable block 22, rising in the direction of stacking the stackable block 23 through the side pattern Pv of the element pattern P8 provided on the stackable block 23, and spreading in the horizontal direction on the upper surface of the stackable block 23 through the plan pattern Ph.

In the antenna device according to the fourth embodiment, the antenna element is not extended in the horizontal direction on the surface of the base substrate 31. Rather, stackable blocks extend the antenna element in the stacking direction from the base substrate 31. Therefore, an antenna module comprising a printed circuit board can be made compact, and an antenna module having a desired configuration of elements can be easily realized.

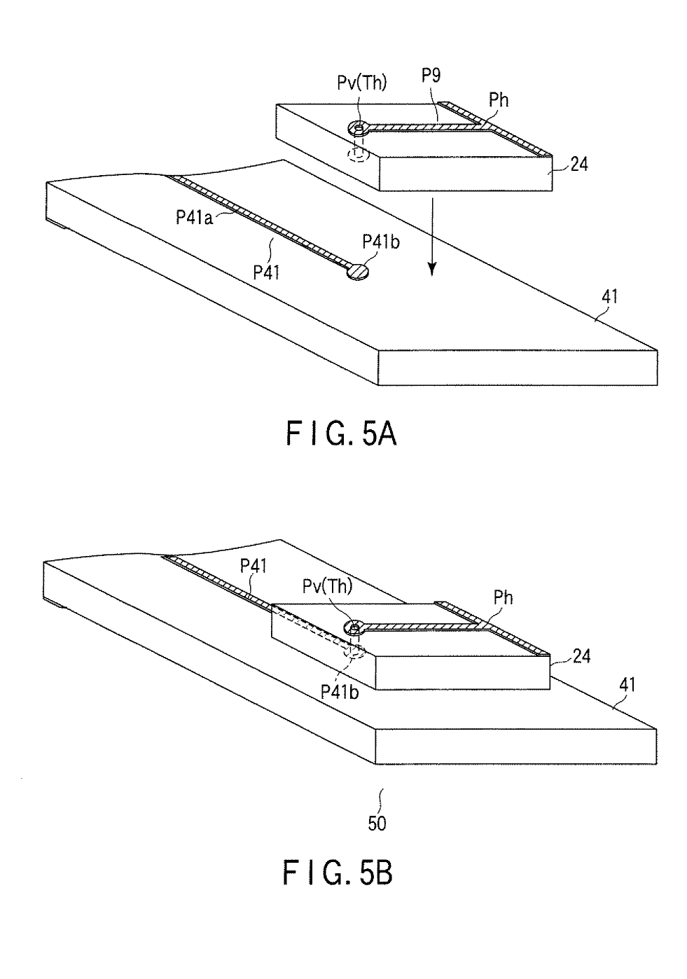

FIGS. 5A and 5B show an example of an antenna device according to a fifth embodiment of the invention. FIG. 5A shows the state before the elements of the antenna device are combined. FIG. 5B shows the state after the elements of the antenna device are combined.

As shown in FIGS. 5A and 5B, the antenna device according to the fifth embodiment comprises a base substrate 41 having a power-feeding pattern P41, a stackable block (substrate) 24 stacked on the base substrate 41 and fixed to the surface of the substrate, the stackable block 24 having an element pattern 9 with one end connected conductively to the power-feeding pattern P41 and the other end extendible in a direction of stacking another stackable block on the stackable block 24.

The power-feeding pattern P41 provided on the base substrate 41 includes an antenna lead P41a and an element connection terminal P41b, which are connected as a circuit to an antenna connector of a now-shown radio unit. The element connection terminal P41b is a pad for connecting a through hole.

The stackable block 24 includes a hexahedral printed circuit board stackable to several stages, and is fixed to the base substrate 41 with an adhesive, for example. The element pattern P9 includes a through pattern Pv made by a through hole (Th) corresponding to the side pattern Pv in each of the embodiments described above, and a T-shaped plan pattern Ph extended from the through pattern Pv and provided on the upper surface of the stackable block 24. The lower end of the through pattern Pv is conductively connected to the element connection terminal P41b (the pad for connecting a through hole) of the power-feeding pattern P41 provided on the base substrate 41.

In such an antenna device formed by stacking the stackable block 24 on the base substrate 41, a cubic antenna 50 is configured, rising from the element connection terminal P41b of the power-feeding pattern P41 to the direction of stacking the block 24 through the through pattern Pv of the element pattern P9, and spreading as a T-shape in the horizontal direction on the upper surface of the stackable block 24 through the plan pattern Ph. The stackable block 24 stacked on the base substrate 41 is not limited to the element pattern configuration shown in the drawing. Stackable blocks of various element configurations may be used, considering the antenna mounting space and required directivity.

In the antenna device formed by stacking a printed circuit board according to the embodiment, an antennal element is not extended along the surface of the base substrate 41, but extended in the direction of stacking the stackable block 24 through the stackable block 24. Therefore, an antenna module comprising a printed circuit board can be made compact, and an antenna module having a desired configuration of elements can be easily realized.

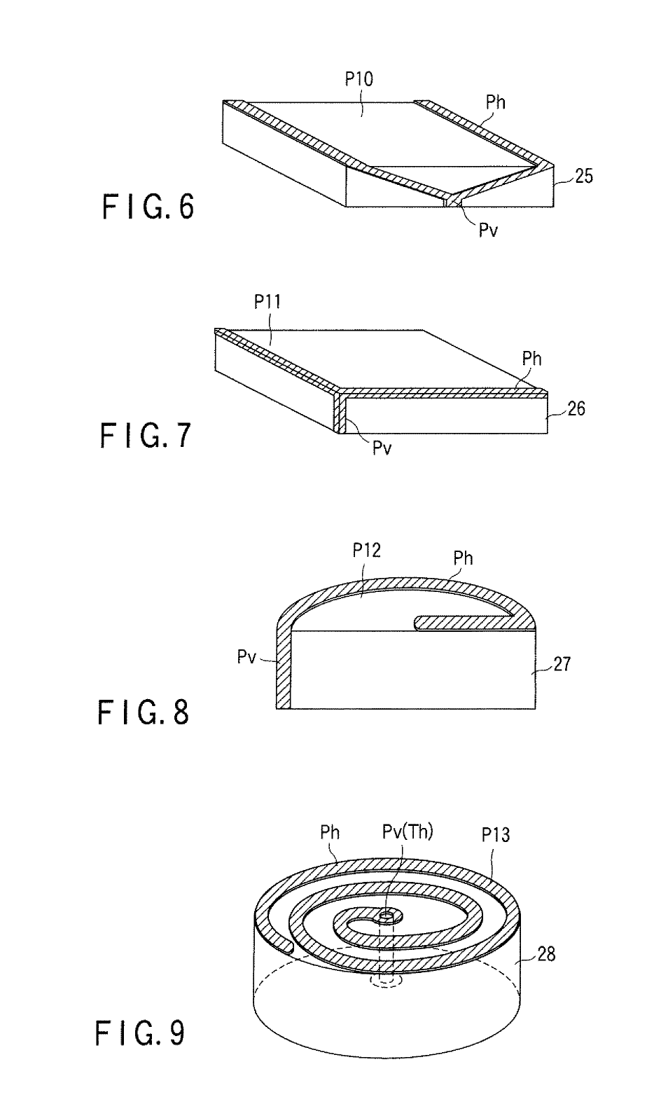

FIG. 6 to FIG. 9 show modifications of a stackable block commonly usable in each embodiment of the invention.

A stackable block (substrate) 25 shown in FIG. 6 illustrates a configuration in which a side pattern Pv is not along the ridge of the stackable block 25. The stackable block 25 shown in FIG. 6 has an element pattern P10 consisting of a Y-shaped side pattern Pv branched into two parts along the diagonal line on one side of the block, and a plan pattern Ph extended from each branch of the Y-shaped side pattern Pv and provided along the ridge of the block. By using the stackable block 25 shown in FIG. 6, a parallel element branched into two parts spreading in the direction orthogonal to the surface of the base substrate can be realized.

A stackable block (substrate) 26 shown in FIG. 7 has an element pattern P11 consisting of a side pattern Pv and plan pattern Ph provided on the ridge of the stackable block 26. By using the stackable block 25 shown in FIG. 7, a Y-shaped antenna element spreading in the direction orthogonal to the surface of the base substrate can be realized.

FIG. 8 shows an example of the configuration of a non-hexahedral stackable block. A stackable block (substrate) 27 shown in FIG. 8 is made of a semi-cylindrical base material having a semi-circular surface, and has an element pattern P12 having a plan pattern Ph extended from the side pattern Pv and provided along the periphery of the semi-circular surface.

By using the stackable block 27 shown in FIG. 8, a curved antenna element spreading in the direction orthogonal to the surface of the base substrate can be realized.

FIG. 9 shows an example of the other configuration of a non-hexahedral stackable block. A stackable block (substrate) 28 shown in FIG. 9 is made of a cylindrical base material, and has an element pattern P11 consisting of a through pattern Pv comprising a through hole (Th), and a spiral plan pattern Ph extended from the through pattern Pv and provided on the upper surface of the stackable block 24.

By using the stackable block 28 shown in FIG. 9, a spiral antenna element spreading in the direction orthogonal to the surface of the base substrate can be realized.

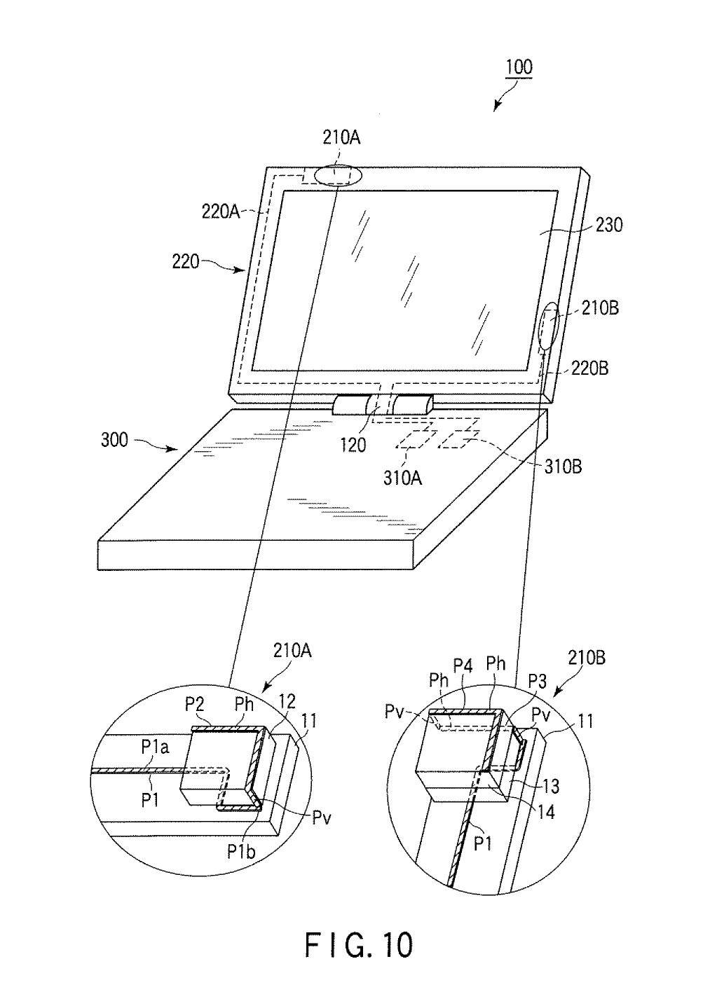

FIG. 10 shows an example of an electronic apparatus using the cubic antenna of the embodiment described above according to a sixth embodiment of the invention.

The electronic apparatus according to the sixth embodiment shown in FIG. 10 has the cubic antennas of the first and second embodiments shown in FIGS. 1A and 1B and FIGS. 2A and 2B.

FIG. 10 shows an external configuration of the electronic apparatus according to the sixth embodiment of the invention. The electronic apparatus shown in the drawing is a personal computer called a tablet PC, for example. A tablet PC 100 has a structure that a display unit 200 having a tablet on a liquid crystal panel (display unit) 230 is fixed pivotally movable to a main unit 300 through a hinge 120.

The display unit 200 is provided with wireless LAN antennas 210A and 210B inside the adjacent two sides. These antenna 210A and 210B are provided at a different angle of 90° from each other, and can receive different polarized waves. In the state that the display unit 200 is opened, the antenna 210A is provided in the upper part of the display unit 200, and the antenna 210B is provided on the side of the display unit 200. One of the antennas 210A and 210B is used as a transmission/receiving antenna capable of receiving and transmitting (i.e., emitting a radio wave), and the other is used as a receive-only antenna.

The main unit 300 is provided with wireless LAN controllers 310A and 310B as a radio module connected to the antennas 210A and 210B. The antenna 210A is connected to the antenna connector of the wireless LAN controller 310A through an antenna lead 220A. The antenna 210B is connected to the antenna connector of the wireless LAN controller 310B through an antenna lead 220B. The antenna leads 220A and 220B are configured by micro strip lines using a flexible printed wiring boards, for example, or a coaxial cable.

The antenna 210A comprises a base substrate 11 having a power-feeding pattern P1, a stackable block 12 stacked on the base substrate 11 and fixed to the surface of the substrate, the stackable block 12 having an element pattern P2 with one end connected conductively to the power-feeding pattern P1 and the other end extendible in a direction of stacking another stackable block on the stackable block 12. The base substrate 11 and stackable block 12 are configured using printed circuit boards. The power-feeding pattern P1 and element pattern P2 are made of conductive foil.

The base substrate 11 has a power-feeding pattern P1 on one side, and a ground pattern GP for impedance matching with the power-feeding pattern P1 on the other side. The power-feeding pattern P1 has an antenna lead P1a and an element connection terminal P1b, which are connected as a circuit to an antenna connector of the wireless LAN controller 310A.

The stackable block 12 includes a hexahedral printed circuit board stackable to several stages, and is fixed to the base substrate 11 with an adhesive, for example. The element pattern P2 has a partial element pattern Pv which is raised in the direction orthogonal to the surface of the base substrate 11, and provided along the ridge on one side of the stackable block 12, and a partial element pattern Ph which is extended from the pattern Pv and provided on the upper surface of the stackable block 12. The partial element pattern Pv is called a side pattern, and the pattern Ph is called a plan pattern. In the embodiment shown in FIG. 10, the side pattern Pv and plan pattern Ph are formed along ridges orthogonal to each other. The lower end of the side pattern Pv is conductively connected to the element connection terminal P1b of the power supply patter P1 provided on the base substrate 11.

In such an antenna device formed by stacking the stackable block 12 on the base substrate 11, the cubic antenna 210A is configured, rising from the element connection terminal P1b of the power-feeding pattern P1 to the direction of stacking the stackable block 12 through the side pattern Pv of the element pattern P2, and spreading in the horizontal direction on the upper surface of the stackable block 12 through the plan pattern Ph.

The antenna 210B comprises a base substrate 11 having a power-feeding pattern P1, a stackable block 13 stacked on the base substrate 11 and fixed to the surface of the substrate, the stackable block 13 having an element pattern P3 with one end connected conductively to the power-feeding pattern P1 and the other end extendible in a direction of stacking another stackable block on the stackable block 13, a stackable block 14 stacked on the stackable block 13 and fixed to the block, the stackable block 14 having an element pattern P4 with one end connected conductively to the extended end of the element pattern P3 provided on the stackable block 13 and the other end extendible in a direction of stacking another stackable block on the stackable block 13.

The stackable blocks 13 and 14 are configured using hexahedral printed circuit boards stackable to several stages, similar to the stackable block 12. The element patterns P3 and P4 provided on the stackable blocks 13 and 14, respectively have the side pattern Pv and plan pattern Ph, as in the stackable block 12. In the element patterns P3 and P4 provided on the stackable blocks 13 and 14, respectively, the side pattern Pv and plan pattern Ph are formed along the ridges orthogonal to each other.

By combining and stacking two stackable blocks 13 and 13 on the base substrate 11, the cubic antenna 210B having an element structure is configured, rising from the element connection terminal P1b of the power-feeding pattern P1 provided on the base substrate 11 to the direction of stacking the stackable block 13 through the side pattern Pv of the element pattern P3 provided on the stackable block 13, extending along the ridge through the plan pattern Ph on the surface of the stackable block 13, rising in the direction of stacking the stackable block 14 through the side pattern Pv of the element pattern P4 provided on the stackable block 14, and spreading in the horizontal direction on the upper surface of the stackable block 14 through the plan pattern Ph.

In the cubic antennas 210A and 210B, the antenna element is not extended in the horizontal direction on the surface of the base substrate 11. Rather, stackable blocks extend the antenna element in the stacking direction from the base substrate 11. Therefore, an antenna module housed in a cabinet of an electronic apparatus can be made compact, and an antenna module having a desired configuration of elements can be easily realized.

As described in detail herein, a cubic antenna with a high degree of flexibility is easily realized in a desired element structure by using a printed circuit board.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An antenna device comprising:
a base substrate having a power-feeding pattern; and
a stackable block stacked on the base substrate and fixed to the surface of the base substrate, the stackable block having an element pattern with one end connected to the power-feeding pattern and the other end extendible in a direction of stacking another stackable block on the stackable block.

2. The antenna device of claim 1, wherein the stackable block includes a hexahedral printed circuit board stackable to several stages, and the element pattern is made of conductive foil.

3. The antenna device of claim 1, wherein the element pattern is at least partially formed along a ridge.

4. The antenna device of claim 1, wherein the element pattern is at least partially formed along ridges orthogonal to each other.

5. The antenna device of claim 1, wherein the element pattern is at least partially formed along a diagonal line on one side.

6. The antenna device of claim 1, wherein the element pattern is at least partially formed by a through hole.

7. The antenna device of claim 1, wherein the stackable block has a semi-circular surface, and the element pattern is provided along the periphery of the semi-circular surface.

8. The antenna device of claim 1, wherein the stackable block has a plurality of element patterns branched from the power-feeding pattern.

9. An antenna device comprising:
a base substrate having a plurality of power-feeding patterns; and
a stackable block stacked on the base substrate and fixed to the surface of the base substrate, the stackable block having a plurality of element patterns with one ends connected respectively to the plurality of power-feeding patterns and the other ends extendible in a direction of stacking another stackable block on the stackable block.

10. An electronic apparatus comprising:
a wireless module; and
an antenna module connected to the wireless module, the antenna module including:
a base substrate having a power-feeding pattern,
a stackable block stacked on the base substrate and fixed to the surface of the base substrate, the stackable block having an element pattern with one end connected to the power-feeding pattern and the other end extendible in a direction of stacking another stackable block on the stackable block.
